(19) United States
(12) Patent Application Publication
(10) Pub. No.: US 2008/0051068 A1
(43) Pub. Date: Feb. 28, 2008

(54) METHOD AND APPARATUS FOR PRESENTING RING BACK TONES

(75) Inventors: STEVEN FREW, PFLUGERVILLE, TX (US); ANIL K. DORADLA, AUSTIN, TX (US)

Correspondence Address: AKERMAN SENTERFITT, P.O. BOX 3188, WEST PALM BEACH, FL, 33402-3188, US

(73) Assignee: SBC KNOWLEDGE VENTURES, L.P., RENO, NV (US)

(21) Appl. No.: 11/466,707

(22) Filed: Aug. 23, 2006

(51) Int. Cl. H04Q 7/22

(52) U.S. Cl. 455/414.1

(57) ABSTRACT

A method and apparatus for presenting ring back tones is disclosed. A system that incorporates teachings of the present disclosure may include, for example, a network management system (NMS) having a tracking element that tracks an approximate location of a subscriber, a detection element that detects the subscriber roaming from a first time zone to a second time zone according to one or more of the approximate locations tracked, and a configuration element for updating a temporal configuration of a ring back tone service of the subscriber according to the second time zone. Additional embodiments are disclosed.

### FIELD OF THE DISCLOSURE

The present disclosure relates generally to communication services, and more specifically to a method and apparatus for presenting ring back tones.

### BACKGROUND

Ring Back Tone (RBT) services allow a subscriber to select an RBT that is played to calling parties during a network origination call directed to a messaging device of the subscriber. Usually, the service is configurable by the subscriber to allow RBTs to be played selectively to calling parties based on time of day, day of week, and calling party number.

An RBT service, however, does not function as intended when a subscriber leaves his/her time zone. For example, a subscriber whose home time zone is Eastern time can establish an RBT service between 6 AM & 6 PM Eastern time. Outside of this range of time the end user can choose to play a normal alert tone to calling parties. If the subscriber now roams to a Pacific time zone (3 hours behind Eastern time) his/her RBT service will continue to operate according to Eastern time which is inconsistent with the subscriber's new location.

A need therefore arises for a method and apparatus for presenting ring back tones.

### BRIEF DESCRIPTION OF THE DRAWINGS

FIG. 1 depicts an exemplary embodiment of a communication system;

FIG. 2 depicts an exemplary method operating in the communication system; and

FIG. 3 depicts an exemplary diagrammatic representation of a machine in the form of a computer system within which a set of instructions, when executed, may cause the machine to perform any one or more of the methodologies disclosed herein.

### DETAILED DESCRIPTION

Embodiments in accordance with the present disclosure provide a method and apparatus for presenting ring back tones.

In a first embodiment of the present disclosure, a computer-readable storage medium can have computer instructions for detecting a subscriber roaming from a first time zone to a second time zone, and updating a configuration of a ring back tone service of the subscriber according to the second time zone.

In a second embodiment of the present disclosure, a network management system (NMS) can have a tracking element that tracks movement of a subscriber, a detection element that detects the subscriber roaming from a first time zone to a second time zone according to the subscriber's movement, and a configuration element for updating a temporal configuration of a ring back tone service of the subscriber according to the second time zone.

In a third embodiment of the present disclosure, a method can have the step of updating a ring back tone service in response to detecting an end user of the ring back tone service roaming between time zones.

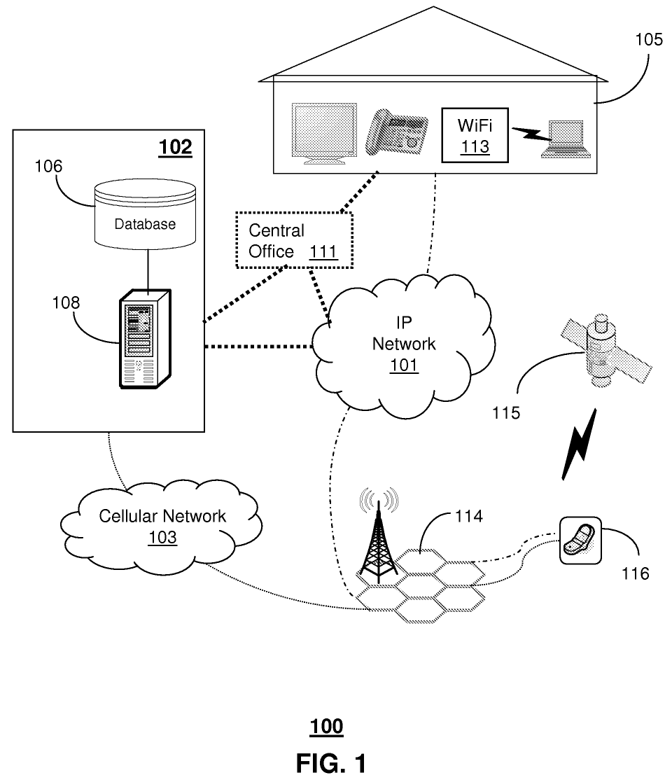

FIG. 1 depicts an exemplary embodiment of a communication system 100. The communication system 100 comprises wired and wireless access points (WAPs). In the case of wireline communications, the WAP can represent a central office 111 coupled to a building 105 by way of a distribution hub such as a service area interface (SAI) not shown. The central office 111 can provide traditional circuit switched services to a plain old telephone service (POTS) terminal. An independent Internet Service Provider (ISP) can provide packet switched or Internet services by way of an IP network 101 that supports packetized voice, video, and data directed to messaging devices 116 such as an IPTV terminal, a Voice over IP (VoIP) terminal, and/or a computer communicating over a WiFi 113 or xDSL interface. Alternatively, such services can be an integral part of the services provided by the central office 111.

For wireless communications, a WAP can represent a plurality of wireless base stations 114 operating according to a frequency reuse architecture that provides over-the-air coverage in a large geographic region to roaming messaging devices 116. The messaging devices 116 can also operate as multimode devices which can interchangeably function on a packet switched or circuit switched network. Accordingly, said roaming devices can utilize POTS or VoIP services when in the building 105, or cellular services outside the building 105. A cellular network 103 can utilize circuit-switched technology that supports voice and data services such as GSM-GPRS, EDGE, CDMA-1X, EV/DO, UMTS, and other known and next generation cellular communications technologies.

Alternatively, or in combination, other wireless access technologies can be applied to the present disclosure such as, for example, a Worldwide Interoperability for Microwave Access (WiMAX), ultra wide band (UWB), Bluetooth™, and software defined radio (SDR). SDR provides a means to access public and private communication spectrum with any number of communication protocols that can be dynamically downloaded over-the-air to the messaging devices 116. Other present and future generation wireless access technologies can also be applied to the present disclosure.

The aforementioned messaging devices 116 can also include a Global Positioning System (GPS) receiver for receiving signals from GPS satellites 115. The messaging devices 116 can thereby determine a location fix of the device and share this information with a network management system (NMS) 102. Alternatively, an approximate location of the messaging device 116 can be determined according to a nearest base station 114 communicating with the messaging device, or by way of common wireless triangulation techniques. In yet another embodiment, the subscriber can communicate with the NMS 102 by way of a website, a human agent, or an interactive voice response (IVR) system to indicate the subscriber's location. The NMS 102 can utilize the location information associated with the messaging device to manage a ring back tone service as will be described shortly. The ring back tone service can be an independent system or integrated with the NMS. To perform the operations of the present disclosure, the NMS 102 can utilize computing technology such as a scaleable server 108 and a memory 106 managed by a common database application.

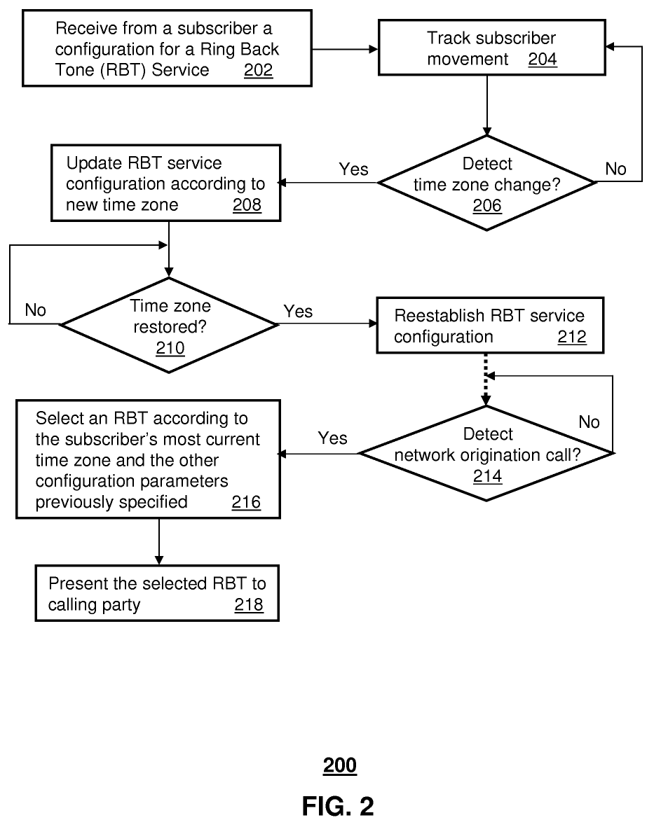

FIG. 2 depicts an exemplary method 200 operating in portions of the communication system 100. Method 200 begins with step 202 in which the NMS 102 can be programmed to receive from a subscriber a configuration for a Ring Back Tone (RBT) service. The configuration established by the subscriber can identify a selection of RBTs, caller ID associations with the RBTs, and a time of day and day of week for determining a time for which to selectively play the RBTs to calling parties. RBTs can represent a musical composition, a recorded voice message from the subscriber, or a synthesized voice message produced from for example a text message supplied by the subscriber.

In step 204, the NMS 102 can be programmed to track the subscriber's movement. This step can be accomplished in several ways. For example, the subscriber can call an agent or an IVR system of the communication system 100 and indicate to the agent or IVR the subscriber's new location or change in time zone. Alternatively, the messaging device 116 of the subscriber can have a GPS receiver which periodically determines a location fix of the device and forwards it to the NMS 102. In yet another embodiment, the closest network element such as a base station 114 located nearest to the subscriber's messaging device 116 can provide its location to the NMS 102, or a number of base stations 114 can perform common triangulation techniques to approximate the subscriber's location.

While the subscriber's location is tracked, the NMS 102 can determine from the locations received in step 204 whether the subscriber has changed time zones by comparing the subscribers location to well known geographic time zone delimiters. If there is no change in time zone, the NMS 102 continues to track the subscriber's movement in step 204. Otherwise, the NMS 102 proceeds to step 208 where it updates the RBT service configuration initially established by the subscriber in step 202 according to the new time zone. The adjustment can mean for example changing the time of day in which RBTs are presented to calling parties (e.g., 6 AM to 6 PM Eastern time) to the new time zone (e.g., 6 AM to 6 PM Pacific time). Steps 210-212 can be applied by the NMS 102 to check for a return of the subscriber to his/her home time zone (e.g., Eastern time zone), and thereby reestablish the original time zone setting in the configuration of the RBT service.

Steps 202-212 can operate as a background process which complements the operation of the RBT service in the foreground as depicted by steps 214-218. In step 214, for example, the NMS 102 can be programmed to detect a network origination call from a calling party. This step can be performed by the NMS 102 by monitoring signaling messages such as SS7, SIP or H.323. When a network origination call is detected, the NMS 102 proceeds to step 216 where it directs the RBT service to select an RBT according to the subscriber's most current time zone and the other configuration parameters previously specified by the subscriber in step 202 such as time of day, day of week, and caller ID. Once the RBT has been selected according to these parameters, it is presented to the calling party in step 218 during the network origination call to the subscriber according to techniques well known in the art.

It would be evident to an artisan with ordinary skill in the art that the foregoing embodiments can be modified, reduced, or enhanced without departing from the scope and spirit of the claims described below. For example, the above embodiments can be applied on a global scale. That is, when a subscriber registers his/her messaging device 116 after traveling internationally, the NMS 102 can determine the subscriber's location from the registration and thereby adjust the configuration with the new time zone. The above embodiments can also be applied to IP communications in which the NMS 102 operates as an IMS or in cooperation therewith. These are but a few examples of how the embodiments above can be changed without departing from the scope of the claims. The reader is therefore directed to the claims below for a fuller understanding of the breadth and scope of the present disclosure.

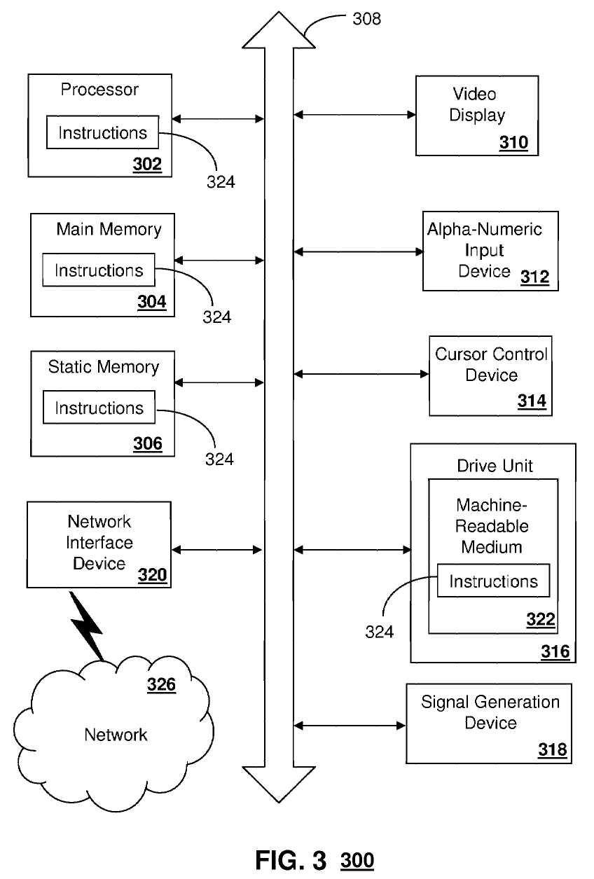

FIG. 3 depicts an exemplary diagrammatic representation of a machine in the form of a computer system 300 within which a set of instructions, when executed, may cause the machine to perform any one or more of the methodologies discussed above. In some embodiments, the machine operates as a standalone device. In some embodiments, the machine may be connected (e.g., using a network) to other machines. In a networked deployment, the machine may operate in the capacity of a server or a client user machine in server-client user network environment, or as a peer machine in a peer-to-peer (or distributed) network environment.

The machine may comprise a server computer, a client user computer, a personal computer (PC), a tablet PC, a laptop computer, a desktop computer, a control system, a network router, switch or bridge, or any machine capable of executing a set of instructions (sequential or otherwise) that specify actions to be taken by that machine. It will be understood that a device of the present disclosure includes broadly any electronic device that provides voice, video or data communication. Further, while a single machine is illustrated, the term “machine” shall also be taken to include any collection of machines that individually or jointly execute a set (or multiple sets) of instructions to perform any one or more of the methodologies discussed herein.

The computer system 300 may include a processor 302 (e.g., a central processing unit (CPU), a graphics processing unit (GPU, or both), a main memory 304 and a static memory 306, which communicate with each other via a bus 308. The computer system 300 may further include a video display unit 310 (e.g., a liquid crystal display (LCD), a flat panel, a solid state display, or a cathode ray tube (CRT)). The computer system 300 may include an input device 312 (e.g., a keyboard), a cursor control device 314 (e.g., a mouse), a disk drive unit 316, a signal generation device 318 (e.g., a speaker or remote control) and a network interface device 320.

The disk drive unit 316 may include a machine-readable medium 322 on which is stored one or more sets of instructions (e.g., software 324) embodying any one or more of the methodologies or functions described herein, including those methods illustrated above. The instructions 324 may also reside, completely or at least partially, within the main memory 304, the static memory 306, and/or within the processor 302 during execution thereof by the computer system 300. The main memory 304 and the processor 302 also may constitute machine-readable media.

Dedicated hardware implementations including, but not limited to, application specific integrated circuits, programmable logic arrays and other hardware devices can likewise be constructed to implement the methods described herein. Applications that may include the apparatus and systems of various embodiments broadly include a variety of electronic and computer systems. Some embodiments implement functions in two or more specific interconnected hardware modules or devices with related control and data signals communicated between and through the modules, or as portions of an application-specific integrated circuit. Thus, the example system is applicable to software, firmware, and hardware implementations.

In accordance with various embodiments of the present disclosure, the methods described herein are intended for operation as software programs running on a computer processor. Furthermore, software implementations can include, but not limited to, distributed processing or component/object distributed processing, parallel processing, or virtual machine processing can also be constructed to implement the methods described herein.

The present disclosure contemplates a machine readable medium containing instructions 324, or that which receives and executes instructions 324 from a propagated signal so that a device connected to a network environment 326 can send or receive voice, video or data, and to communicate over the network 326 using the instructions 324. The instructions 324 may further be transmitted or received over a network 326 via the network interface device 320.

While the machine-readable medium 322 is shown in an example embodiment to be a single medium, the term “machine-readable medium” should be taken to include a single medium or multiple media (e.g., a centralized or distributed database, and/or associated caches and servers) that store the one or more sets of instructions. The term “machine-readable medium” shall also be taken to include any medium that is capable of storing, encoding or carrying a set of instructions for execution by the machine and that cause the machine to perform any one or more of the methodologies of the present disclosure.

The term “machine-readable medium” shall accordingly be taken to include, but not be limited to: solid-state memories such as a memory card or other package that houses one or more read-only (non-volatile) memories, random access memories, or other re-writable (volatile) memories; magneto-optical or optical medium such as a disk or tape; and carrier wave signals such as a signal embodying computer instructions in a transmission medium; and/or a digital file attachment to e-mail or other self-contained information archive or set of archives is considered a distribution medium equivalent to a tangible storage medium. Accordingly, the disclosure is considered to include any one or more of a machine-readable medium or a distribution medium, as listed herein and including art-recognized equivalents and successor media, in which the software implementations herein are stored.

Although the present specification describes components and functions implemented in the embodiments with reference to particular standards and protocols, the disclosure is not limited to such standards and protocols. Each of the standards for Internet and other packet switched network transmission (e.g., TCP/IP, UDP/IP, HTML, HTTP) represent examples of the state of the art. Such standards are periodically superseded by faster or more efficient equivalents having essentially the same functions. Accordingly, replacement standards and protocols having the same functions are considered equivalents.

The illustrations of embodiments described herein are intended to provide a general understanding of the structure of various embodiments, and they are not intended to serve as a complete description of all the elements and features of apparatus and systems that might make use of the structures described herein. Many other embodiments will be apparent to those of skill in the art upon reviewing the above description. Other embodiments may be utilized and derived therefrom, such that structural and logical substitutions and changes may be made without departing from the scope of this disclosure. Figures are also merely representational and may not be drawn to scale. Certain proportions thereof may be exaggerated, while others may be minimized. Accordingly, the specification and drawings are to be regarded in an illustrative rather than a restrictive sense.

Such embodiments of the inventive subject matter may be referred to herein, individually and/or collectively, by the term “invention” merely for convenience and without intending to voluntarily limit the scope of this application to any single invention or inventive concept if more than one is in fact disclosed. Thus, although specific embodiments have been illustrated and described herein, it should be appreciated that any arrangement calculated to achieve the same purpose may be substituted for the specific embodiments shown. This disclosure is intended to cover any and all adaptations or variations of various embodiments. Combinations of the above embodiments, and other embodiments not specifically described herein, will be apparent to those of skill in the art upon reviewing the above description.

The Abstract of the Disclosure is provided to comply with 37 C.F.R. § 1.72(b), requiring an abstract that will allow the reader to quickly ascertain the nature of the technical disclosure. It is submitted with the understanding that it will not be used to interpret or limit the scope or meaning of the claims. In addition, in the foregoing Detailed Description, it can be seen that various features are grouped together in a single embodiment for the purpose of streamlining the disclosure. This method of disclosure is not to be interpreted as reflecting an intention that the claimed embodiments require more features than are expressly recited in each claim. Rather, as the following claims reflect, inventive subject matter lies in less than all features of a single disclosed embodiment. Thus the following claims are hereby incorporated into the Detailed Description, with each claim standing on its own as a separately claimed subject matter.

What is claimed is:

1. A computer-readable storage medium, comprising computer instructions for:
detecting a subscriber roaming from a first time zone to a second time zone; and
updating a configuration of a ring back tone service of the subscriber according to the second time zone.

2. The storage medium of claim 1, wherein the configuration comprises a selection by the subscriber of one or more ring back tones enabled according to a first temporal setting, and wherein the storage medium comprises computer instructions for adjusting the configuration to a second temporal setting in response to detecting the second time zone.

3. The storage medium of claim 2, comprising computer instructions for enabling a select one of the one or more ring back tones during a network origination call (NOC) according to at least one among a time of day and a day of week in which the NOC is initiated.

4. The storage medium of claim 2, comprising computer instructions for enabling a select one of the one or more ring back tones during a network origination call (NOC) according to at least one among a time of day and a day of week in which the NOC is initiated and an identification of a calling party.

5. The storage medium of claim 2, comprising computer instructions for reestablishing in the configuration the first temporal setting in response to detecting the subscriber roaming to the first time zone.

6. The storage medium of claim 1, comprising computer instructions for:
tracking an approximate location of the subscriber; and
detecting from a select one or more of the approximate locations tracked the subscriber roaming from the first time zone to the second time zone.

7. The storage medium of claim 6, comprising computer instructions for receiving from the subscriber a message corresponding to the subscriber's approximate location.

8. The storage medium of claim 7, wherein the message comprises one among a location coordinate from a messaging device of the subscriber, a location of a network element near the messaging device of the subscriber, a triangulation coordinate approximating a location of the messaging device, and a location descriptor from the subscriber entered by way of an interactive voice response (IVR) system.

9. The storage medium of claim 1, comprising computer instructions for receiving from the subscriber a message indicating the subscriber has moved to the second time zone.

10. The storage medium of claim 1, comprising computer instructions for:
receiving a registration request from a messaging device of the subscriber; and
detecting from the registration request the change from the first time zone to the second time zone.

11. A network management system (NMS), comprising:
a tracking element that tracks movement of a subscriber;
a detection element that detects the subscriber roaming from a first time zone to a second time zone according to the subscriber's movement; and
a configuration element for updating a temporal configuration of a ring back tone service of the subscriber according to the second time zone.

12. The NMS of claim 11, wherein the configuration comprises a selection by the subscriber of one or more ring back tones enabled according to a first temporal setting, and wherein the configuration element updates the configuration to a second temporal setting in response to detecting the second time zone.

13. The NMS of claim 12, comprising a ring back tone generator that presents to a calling party a select one of the one or more ring back tones during a network origination call (NOC) according to at least one among a time of day, and a day of week in which the calling party initiated the NOC.

14. The NMS of claim 13, wherein the one or more ring back tones comprise at least one among a musical composition, a recorded voice message from the subscriber, and a synthesized voice message from the subscriber.

15. The NMS of claim 12, comprising a ring back tone generator that presents to a calling party a select one of the one or more ring back tones during a network origination call (NOC) according to at least one among a time of day, and a day of week in which the NOC is initiated and an identification received from the calling party.

16. The NMS of claim 12, wherein the configuration element reestablishes in the configuration the first temporal setting in response to detecting the subscriber roaming to the first time zone.

17. The NMS of claim 11, wherein the tracking element receives from the subscriber a message corresponding to the subscriber's movement, and wherein the message comprises one among a location coordinate from a messaging device of the subscriber, a location of a network element near the messaging device of the subscriber, a triangulation coordinate approximating a location of the messaging device, and a location descriptor from the subscriber entered by way of an interactive voice response (IVR) system.

18. The NMS of claim 11, comprising an IP Multimedia Subsystem (IMS) that adjusts the ring back tone service according to the second time zone.

19. A method, comprising updating a ring back tone service in response to detecting an end user of the ring back tone service roaming between time zones.

20. The method of claim 19, comprising updating a presentation time of one or more ring back tones selected by the end user according to the detected change in time zones.
